(19) United States
(12) Patent Application Publication
(10) Pub. No.: US 2026/0359301 A1
(43) Pub. Date: Nov. 12, 2026

(54) METHOD AND SYSTEM ARRANGEMENT FOR EFFICIENTLY QUERYING A DATABASE SYSTEM

(71) Applicant: Patentpool Target GmbH, Muenchen (DE)

(72) Inventor: Frank SCHLOER, Muenchen (DE)

(73) Assignee: Patentpool Target GmbH, Muenchen (DE)

(21) Appl. No.: 19/129,745

(22) PCT Filed: Sep. 26, 2023
(86) PCT No.: PCT/EP2023/076482

§ 371 Date: May 14, 2025

(30) Foreign Application Priority Data
Nov. 17, 2022 (EP) 22207977.4

(51) Int. Cl. G06F 16/2455; G06F 16/2458; G06F 16/25

(52) U.S. Cl. CPC G06F 16/24568; G06F 16/2471; G06F 16/252

(57) ABSTRACT

The present invention is directed to a method for controlling and efficiently querying a database system, which makes it possible that it is not necessary to start various queries for a specific data set, but rather configuration data can be stored which is checked iteratively. Thus, according to the invention, it is possible that a complete query does not always have to be made repeatedly with all parameters, but rather individual configuration data can already be realized in a data set and as soon as all specified configuration data is available, a response is transmitted. This increases the system throughput as, on the one hand, not all search criteria always have to be checked and, on the other hand, the query can be stored in a monitor unit, which proactively searches a database system and delivers a result as soon as all configuration data has been found. In this way, a database system is queried particularly efficiently and the system throughput is improved. The invention is further directed to an appropriately configured system arrangement comprising a database system and is further directed to a computer program product with control instructions which execute the proposed method or operate the proposed system arrangement. Furthermore, a computer readable storage medium is proposed.

The present invention is directed to a method for controlling and efficiently querying a database system, which makes it possible that it is not necessary to start various queries for a specific data set, but rather configuration data can be stored which is checked iteratively. Thus, according to the invention, it is possible that a complete query does not always have to be made repeatedly with all parameters, but rather individual configuration data can already be realized in a data set and as soon as all specified configuration data is available, a response is transmitted. This increases the system throughput as, on the one hand, not all search criteria always have to be checked and, on the other hand, the query can be stored in a monitor unit, which proactively searches a database system and delivers a result as soon as all configuration data has been found. In this way, a database system is queried particularly efficiently and the system throughput is improved. The invention is further directed to an appropriately configured system arrangement comprising a database system and is further directed to a computer program product with control instructions which execute the proposed method or operate the proposed system arrangement. Furthermore, a computer readable storage medium is proposed.

EP 1877932 B1 shows a method for the aggregation and analysis of decentralized stored multimedia data, whereby one or more linkable search terms are stored in a data memory.

EP 2538347 B1 shows a data processing system for the dynamic acquisition of weighted correlations between data representing information in at least one dataset.

Database monitoring programs that check the function of a database and then carry out a failure detection are known from the state of the art. Such programs are also known as watch dogs. For this purpose, system parameters are regularly read out and, for example, response times are measured. If the database or database management system is not functioning properly, either an error message is sent to the administrator or the system is restarted. Back-up systems are also known to take over if the first database system fails.

It is known from the state of the art that a user specifies several parameters in a search query and this search query is then transmitted to a database management system. The existing data records in the database management system are then evaluated with regard to the search criteria and a result is returned. In general, the returned result does not have to correspond completely to the search query, but rather it is known to calculate a match of the existing data records with the search query and then return a list that is prioritized in such a way that the result with the greatest match is arranged higher up.

If a user searches for a specific data record that does not yet exist, a result is typically returned anyway and weighted accordingly. However, this is not what the user wants if they want to view exactly the specified data record. The return value is often irrelevant to the user, as they often want to receive a specific data set and are not satisfied with a certain match. This means that the user's expectations are not met in this scenario and the user receives useless search results and also has to specify their query again at a later time. The user is therefore expected to find the data record they are looking for at a later point in time and if this is not the case again, the user must iteratively submit a query again at a later point in time. However, this procedure reduces acceptance of the system provided and also reduces the system throughput. One reason for this is that the search query has to be completely re-specified and transmitted each time. A completely new database query is then performed, which in turn consumes system resources. The effort increases with each new search query and thus the system throughput is reduced.

In the state of the art, there is therefore the problem that a large number of requests are made due to inadequate return parameters, each of which causes effort for the user and also costs system resources. This in turn can only be achieved by increasing the system capacities, which in turn leads to a technical effort.

It is also known from the state of the art to temporarily store search queries and to store search results at the same time. So if a first user makes a query, it is calculated and the result is stored persistently. If a second user now makes the same query with a time delay, no actual database query is carried out, but rather the previously saved result is returned. This return therefore does not necessarily take into account the up-to-dateness of the current data status, but rather simply presents past results again.

In the state of the art, there is a need to create a system that enables up-to-date database queries to be provided that fulfill all search query specifications and that the user is not expected to make repeated queries. There is also a need to create a method or system that proactively queries a database and only returns a corresponding response if the search result is correct.

Thus, the objective technical task of the present invention is to provide a method which enables efficient querying of a database or a database system. To this end, system resources are to be conserved and unnecessary database queries are to be avoided. Furthermore, it is a task of the present invention to provide a correspondingly equipped system arrangement as well as a computer program product and a storage medium.

The problem is solved with the features of claim 1. Further advantageous embodiments are given in the subclaims.

Accordingly, a method for controlling and efficiently querying a database system with improved system throughput is proposed, comprising setting up a communication channel between a query unit and a monitor unit connected upstream of the database system; structuring a query to the database system by the query unit in such a way that a plurality of configuration data of a data set to be provided but not yet existing is specified; persistently storing the structured query in the monitor unit by means of the communication channel set up by the query unit; iteratively checking the configuration data of the data set to be provided by the monitor unit; and reading the data set from the database system by the monitor unit and transmitting the data set to the query unit by means of the communication channel set up as soon as the data set is available in accordance with all the specified configuration data.

The method is used to efficiently control and query a database system. A database system is a database together with a functionality that enables access to the data. It is therefore the database itself together with a database management system or a module that has read and write access to the database. The query is particularly efficient, as the query can be made once and then the query is stored persistently. The database system only returns a value if all search criteria are available. It is therefore quite possible that the return is delayed, which is even the typical case here, as the data records are typically not yet available. There is therefore no iterative query, for which the user receives return values that do not fully correspond to his query, but rather the user must be satisfied with the fact that a certain period of time may pass until the data records are available. For this purpose, a time-out can also be specified, which indicates, for example, after an error message is returned. This is the case if the requested data record is not available within the specified time period.

In a preparatory process step, a communication channel is set up between a query unit and a monitor unit connected upstream of the database system. The query unit may be a technical device of the user or no human intervention may be necessary and the query unit creates queries automatically. For this purpose, a connection is established between the query unit and a monitor unit, whereby the monitor unit in turn has access to the database system. The database system can also only be the database itself and the monitor unit takes over the functionality that accesses the database in read write mode.

The communication channel can be set up in such a way that a so-called token is created with which the request unit transmits requests to the monitor unit. This makes it possible to implement a separate assignment of rights and create corresponding security precautions. For example, the communication channel can be specially secured.

Furthermore, a query to the database system is structured by the query unit in such a way that a plurality of configuration data is specified. This is therefore the creation of a search query, although not just a single criterion is provided. Rather, a plurality of configuration data, i.e. at least three configuration data, is provided. This specifies a data set that is requested but is not yet available in the database system or database. If the data set is available or exists, conventional technical gauges can be used and the specified data set can be returned immediately. The configuration data describes the properties of the data set and, in particular, describes exactly which data set is expected by the query unit or by the user. The data set should be provided by the database system and transmitted to the request unit via the monitor unit.

Structuring can take place in such a way that the configuration data is structured hierarchically and then queried according to this hierarchy. In this way, configuration data, which is typically also implemented in this way in existing data records, can be queried first and more specific configuration data last. In this way, it is possible to prioritize the configuration data so that the query can run in a structured manner. The hierarchy, for example a tree structure, can also have several levels so that the configuration data is structured in such a way that configuration data is first checked on a first configuration level and then on a second.

According to a further process step, the structured request is stored persistently in the monitor unit by means of the communication channel set up by the request unit. This means that the request is stored in a persistent data memory and not just in a buffer memory. This is the case because the data set that was requested is not yet available and it is therefore not possible to return the requested data set in real time. Instead, the request is stored at least until the available data record is available or a time-out occurs.

As soon as the structured request is persistently stored in the monitor unit, it can iteratively check the configuration data in the database system. This means that the database system checks whether a data record can be provided that fulfills all configuration data. The iterative check can take place at intervals that are specified in such a way that they are carried out after a regular time or an iterative check takes place as soon as new data records are found in the database system or existing data records are changed with regard to their configuration data.

As soon as the data record is available, i.e. a data record containing the specified configuration data is stored in the database system, it is read out and returned. Accordingly, the data set is read from the database system by the monitor unit and the data set is sent to the request unit. For example, there is a data record in the database system that contains two of three configuration data. A request is then made and the system recognizes that a data record is available that contains almost all of the configuration data. If this data record is now modified in such a way that all three configuration data are available, it is returned. It is also possible that the non-existent data set is created and the system then recognizes that a new data set is available that contains all configuration data. This is then returned. According to the invention, a new request is not transmitted by the user each time, but rather the request is saved and if the data set is found with a time delay, the request is answered. This means that it is accepted that the request will only be answered at a later point in time. The user does not have to search the database again each time, but can rely on the method according to the invention to proactively return the data record searched for if it is available.

According to the invention, it is possible, for example, to search for a data record that was created by a specific person and was created at a specific location according to a stored location information. In addition, a time is specified at which the data record is to be created. The proposed method checks all configuration data and only sends a data record if all three criteria are met. The configuration data can be, for example, a person, a group, a concept, an object, a geographical location, a technology, an event or a point in time. As the query is structured, dependencies between the configuration data can also be specified. Such a dependency can in turn be coded as a configuration data unit.

According to one aspect of the present invention, persistent storage takes place in a decentralized data memory. This has the advantage that different database systems can be addressed in a distributed manner and thus load management or optimized load distribution can be carried out. In addition, it is possible for the monitor unit to be distributed across several units and it is therefore possible to read out from different data sources in a computer network whether a data set to be provided is available. The database system can generally have different data sources, which can be distributed in a computer network.

According to a further aspect of the present invention, the request unit is distributed decentrally in a computer network. This has the advantage that a collective query is possible and that the query units can also search decentrally in the computer network. In this way, several query units can in turn address several monitor units and thus an efficient search in the computer network is possible.

According to a further aspect of the present invention, a relative absolute time period is defined after which the method terminates. This has the advantage that a termination criterion or a time-out can be defined, which specifies when the method is terminated. For this purpose, an error message can be returned and the user or the request unit can be informed that no corresponding data record was found within the time period.

According to a further aspect of the present invention, the database system accesses data sources distributed in a computer network. This has the advantage that the database system can also query decentralized data sources and thus the database system can return a uniform response which, however, originates from different data sources. Overall, the distributed nature of the computer network makes it possible for data records to be combined in such a way that they fulfill the specified configuration data. For example, if three configuration data sets are specified, a single data set can be compiled from different data sources that fulfils all three configuration data sets, whereby the partial data sets each only realize one configuration data unit. The database system or the monitor unit can therefore combine various partial data sets, whereby each partial data set corresponds to at least one configuration data unit and the data set as a whole corresponds in its composite form to all specified configuration data.

According to a further aspect of the present invention, the request unit, the monitor unit and the database system are connected in series for communication purposes. This has the advantage that the monitor unit mediates between the request unit and the database system. It is therefore possible to implement a security aspect in such a way that the request unit does not access the database system directly. This means that rights management or a filter can be implemented in the monitor unit.

According to a further aspect of the present invention, the request unit, the monitor unit and the database system are connected in series for communication purposes, with at least one unidirectional path being provided. This has the advantage that communication can only take place in one direction and that a separate return channel is provided. In this way, it is possible not to receive return values directly on the communication path, but rather a circuit is implemented according to this topology, which communicates from the request unit, to the monitor unit and to the database system and then communicates directly from the database system to the request unit or from the monitor unit to the request unit. This means that separate paths are implemented for each communication direction. This can be done using hardware or software.

According to a further aspect of the present invention, the configuration data provides an indication of a geolocation a file attribute of the data set. This has the advantage that it is possible to specify where the data set is stored or which file attributes the data set must have. The geolocation is the geographical coordinate at which the data set is stored. In this way, a particularly close data center can be specified and, for example, a file size can be specified as a file attribute.

According to a further aspect of the present invention, the configuration data specifies a time at which the data record is created or modified. This has the advantage that further temporal information can be stored and thus data records can also be specified that are only created or changed in the future. For example, a data record can be returned as soon as it has been edited by another user.

According to a further aspect of the present invention, the configuration data is provided as a logical expression with different conditions. This has the advantage that a structured expression or a structured request can be made and, in addition to the normal configuration data, which are statically defined, conditions can also be specified which describe dependencies between the configuration data.

According to a further aspect of the present invention, the configuration data describes a change history that a data set goes through. This has the advantage that a sequence of write operations can be specified and if this is recognized, the corresponding data set is returned. With the change history, it is also possible to specify that a data record is read and then written. This allows a sequence of read and write operations to be specified that describe a general history of the configuration data. If this is recognized, the corresponding data record is returned.

According to a further aspect of the present invention, semantic data relating to the data set is provided in addition to the configuration data, which must also be available prior to transmission. This has the advantage that content specifications can also be provided, which the searched data set and then returned data set must have.

The task is also solved by a system arrangement comprising a database system with improved system throughput, having an interface device set up for setting up a communication channel between a query unit and a monitor unit connected upstream of the database system; a query unit set up for structuring a query to the database system in such a way that a plurality of configuration data of a data set to be provided but not yet existing is specified; a memory unit set up for persistently storing the structured query in the monitor unit by means of the communication channel set up by the query unit; the monitor unit set up for iteratively checking the configuration data of the data set to be provided; and the monitor unit set up for reading the data set from the database system and for transmitting the data set to the query unit by means of the communication channel set up as soon as the data set is available in accordance with all the specified configuration data.

The task is also solved by a computer program product with control commands that implement the proposed method or operate the proposed device.

According to the invention, it is particularly advantageous that the method can be used to operate the proposed devices and units. Furthermore, the proposed devices and units are suitable for carrying out the method according to the invention. Thus, in each case the device implements structural features which are suitable for carrying out the corresponding method. However, the structural features can also be designed as method steps. The proposed method also provides steps for implementing the function of the structural features. In addition, physical components can also be provided virtually or virtualized.

Further advantages, features and details of the invention are apparent from the following description, in which aspects of the invention are described in detail with reference to the drawings. The features mentioned in the claims and in the description may each be essential to the invention individually or in any combination. Likewise, the above-mentioned features and the features further described herein may be used individually or in any combination. Functionally similar or identical parts or components are sometimes provided with the same reference signs. The terms “left”, “right”, “top” and “bottom” used in the description of the embodiments refer to the drawings in an orientation with a normally legible figure designation or normally legible reference signs. The embodiments shown and described are not to be understood as conclusive, but are exemplary in nature for the purpose of explaining the invention. The detailed description is for the information of the skilled person, therefore known circuits, structures and methods are not shown or explained in detail in the description so as not to make the present description more difficult to understand. The figures show

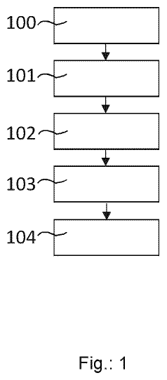

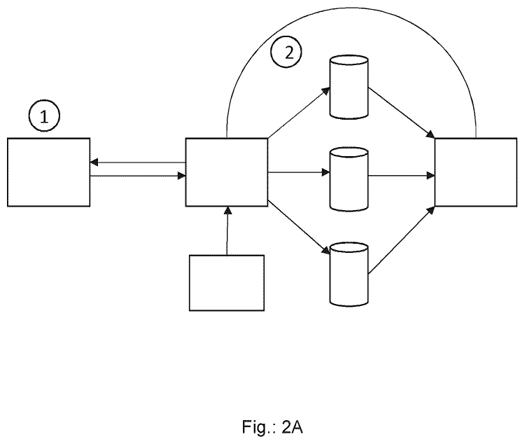

FIG. 1: a schematic flowchart of a method for driving and efficiently querying a database system according to one aspect of the present invention; and

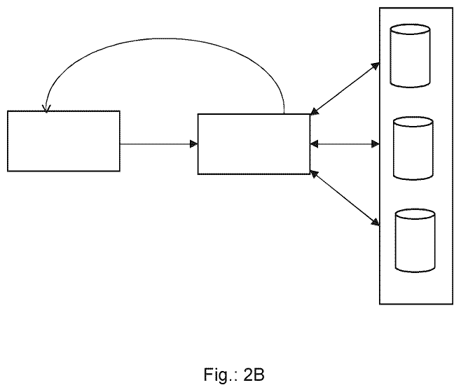

FIGS. 2A and 2B: in each case a schematic block diagram of a system arrangement comprising a database system according to a further aspect of the present invention.

FIG. 1 shows in a schematic flow chart a method for controlling and efficiently querying a database system with improved system throughput, comprising setting up 100 a communication channel between a query unit and a monitor unit connected upstream of the database system; structuring 101 a query to the database system by the query unit in such a way that a plurality of configuration data of a data set to be provided but not yet available is specified; a persistent storage 102 of the structured 101 query in the monitor unit by means of the established 100 communication channel by the query unit; an iterative checking 103 of the configuration data of the data set to be provided by the monitor unit; and a reading 104 of the data set from the database system by the monitor unit and transmission of the data set to the query unit by means of the established communication channel as soon as the data set is available in accordance with all specified configuration data.

FIG. 2A shows a schematic block diagram of the request unit on the left-hand side, which communicates with the monitor unit by means of a unidirectional data path. The monitor unit communicates with three exemplary data sources. The three data sources can be part of the database system. According to the invention, it is possible that the communication path set up is unidirectional, which is why a further unidirectional return path is set up. This is shown here with reference number 1. The communication channel set up is therefore two data paths, each of which is unidirectional. The data channel can therefore be described as simplex or dual-simplex. The data channel can be set up in terms of hardware or software in such a way that each communication direction is implemented via a separate communication channel. A return unit is specified on the far right-hand side in the present FIG. 2A, which returns data to the monitor unit by means of the arrow with reference 2 when the data set is present in accordance with a configuration data. Shown below is a unit which optionally provides further parameters, for example a time period after which the process terminates if the data set was not found.

FIG. 2B shows a similar arrangement, with a database system comprising the three data sources shown on the far right-hand side. The number three is again only introduced as an example. In this case, bidirectional paths are drawn between the database system and the monitor unit in the center. The return from the monitor unit in the middle to the request unit on the left is again exemplary unidirectional with separate communication paths.

1. A method for controlling and efficiently querying a database system with improved system throughput, comprising:
setting up (100) a communication channel between a query unit and a monitor unit connected upstream of the database system;
structuring (101) of a query to the database system by the query unit in such a way that a plurality of configuration data of a data set to be provided but not yet existing is specified;
a persistent storage (102) of the structured (101) request in the monitor unit by means of the established (100) communication channel by the request unit;
an iterative checking (103) of the configuration data of the data set to be provided by the monitor unit; and
a readout (104) of the data record from the database system by the monitor unit and transmission of the data record to the request unit by means of the established communication channel as soon as the data record is available in accordance with all specified configuration data.

2. The method according to claim 1, characterized in that the persistent storage (102) takes place in a decentralized data memory.

3. The method according to claim 1, characterized in that the request unit is distributed decentrally in a computer network.

4. The method according to claim 1, characterized in that a relative and/or absolute time period is defined after which the method terminates.

5. The method according to claim 1, characterized in that the database system accesses data sources distributed in a computer network.

6. The method according to claim 1, characterized in that the inquiry unit, the monitor unit and the database system are connected in series for communication purposes.

7. The method according to claim 1, characterized in that the request unit, the monitor unit and the database system are connected in series in a communicative manner, at least one unidirectional path being provided.

8. The method according to claim 1, characterized in that the configuration data provide an indication of a geolocation and/or a file attribute of the data set.

9. The method according to claim 1, characterized in that the configuration data specify a time at which the data set is created or modified.

10. The method according to claim 1, characterized in that the configuration data is provided as a logical expression with different conditions.

11. The method according to claim 1, characterized in that the configuration data describe a change history which runs through a data set.

12. The method according to claim 1, characterized in that semantic data relating to the data set are provided in addition to the configuration data, which must also be available before transmission.

13. A system arrangement comprising a database system with improved system throughput, comprising:
an interface device for setting up (100) a communication channel between a query unit and a monitor unit connected upstream of the database system;
a query unit set up for structuring (101) a query to the database system in such a way that a plurality of configuration data of a data set to be provided but not yet existing is specified;
a memory unit arranged for persistently storing (102) the structured (101) request in the monitor unit by means of the established (100) communication channel by the request unit;
the monitor unit is arranged for iteratively checking (103) the configuration data of the data set to be provided; and
the monitor unit is set up for reading (104) the data record from the database system and for transmitting the data record to the request unit by means of the communication channel set up as soon as the data record is available in accordance with all the specified configuration data.

14. A computer program product comprising instructions which, when the program is executed by at least one computer, cause the computer to perform the steps of the method according to claim 1.

15. A computer-readable storage medium comprising instructions which, when executed by at least one computer, cause the computer to perform the steps of the method according to claim 1.
